(19) United States
(12) Patent Application Publication
(10) Pub. No.: US 2010/0169041 A1
(43) Pub. Date: Jul. 1, 2010

(54) SYSTEM AND METHOD FOR DISPLAYING ILLUSTRATIVE INFORMATION OF MEASURED DATA

(75) Inventors: CHIH-KUANG CHANG, Tu-Cheng,Taipei Hsien (TW); LI JIANG, Shenzhen City (CN); ZHONG-KUI YUAN, Shenzhen City (CN); YI-RONG HONG, Shenzhen City (CN); YAN-LI LI, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD, Shenzhen City (CN); HON HAI PRECISION INDUSTRY CO., LTD., Tu-Cheng, Taipei Hsien (TW)

(21) Appl. No.: 12/615,365

(22) Filed: Nov. 10, 2009

(30) Foreign Application Priority Data
Dec. 27, 2008 (CN) 200810306579.9

(51) Int. Cl. G01B 5/008

(52) U.S. Cl. 702/150

(57) ABSTRACT

A method for dynamically displaying illustrative information of measured data of a manufactured part, obtained by a coordinate measuring machine, defines measured characteristics of the measured data. Graphical aides are created. Each of the defined measured characteristics is related to one of the graphical aides. If one of the defined measured characteristics is to be illustrated, the related graphical aide is retrieved and displayed.

### BACKGROUND

1. Field of the Invention

Embodiments of the present disclosure relate to displaying measured data, and particularly to a system and method for dynamically displaying illustrative information of measured data.

2. Description of Related Art

Coordinate measuring machines (CMMs) are widely used in the manufacturing industry to measure manufactured parts. Generally speaking, measured data of a manufactured part obtained by a CMM comprise a number of surface features (e.g., lines, planes, circles, spheres, cylinders, and cones) of the manufactured part. The surface features are characterized by various measured characteristics (e.g., straightness, flatness, circularity, and parallelism). The relationship between the surface features may be complex. Therefore, users may be bewildered by the measured characteristics.

### BRIEF DESCRIPTION OF THE DRAWINGS

FIG. 1 is a block diagram of one embodiment of a computing system for dynamically displaying illustrative information of measuring data.

FIG. 2 illustrates an information displaying unit of the computing system of FIG. 1 comprising function modules.

FIG. 3 is a flowchart of one embodiment of a method for dynamically displaying illustrative information of measured data.

FIG. 4 illustrates one embodiment of a graphical aide depicting a line-circle distance from a line to a circle.

### DETAILED DESCRIPTION OF CERTAIN INVENTIVE EMBODIMENTS

All of the processes described below may be embodied in, and fully automated via, functional code modules executed by one or more general purpose computers or processors. The code modules may be stored in any type of computer-readable medium or other computer storage device. Some or all of the methods may alternatively be embodied in specialized computer hardware.

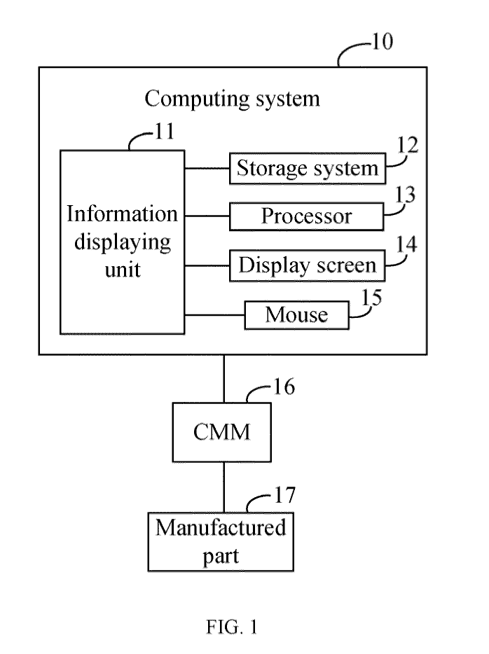

FIG. 1 is a block diagram of one embodiment of a computing system 10 for dynamically displaying illustrative information of measured data. The computing system 10 may include an information displaying unit 11, a storage system 12, a processor 13, a display screen 14, and a mouse 15. One or more computerized codes of the information displaying unit 11 may be stored in the storage system 12 and executed by the processor 13.

In one embodiment, the computing system 10 is connected to a coordinate measuring machine (CMM) 16. The CMM 16 may be used to measure a manufactured part 17 to obtain measured data of the manufactured part 17. The measured data may comprise a plurality of surface features of the manufactured part 17, such as lines, planes, circles, spheres, cylinders, and cones, for example. The measured data may further comprise various measured characteristics describing the surface features. The relationship between the surface features may be complex. Thus, the variety of the measured characteristics may be confusing. The manufactured part 17 may be a computer case, or an electronic mouse, for example.

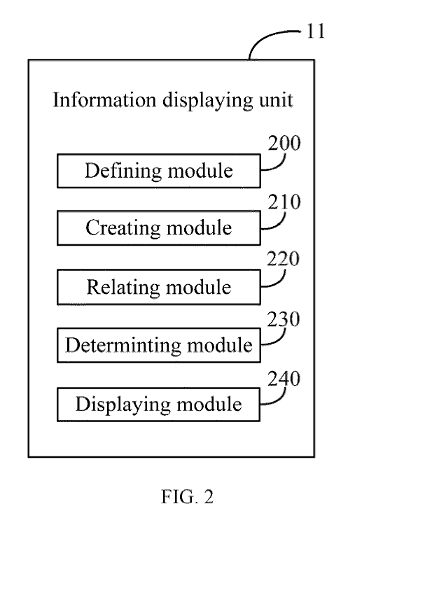

FIG. 2 illustrates the information displaying unit 11 comprising function modules. In one embodiment, the information displaying unit 11 includes a defining module 200, a creating module 210, a relating module 220, a determining module 230, and a displaying module 240.

The defining module 200 is operable to define the measured characteristics in the measured data. In one embodiment, the defined measured characteristics include various geometric tolerances, such as straightness, flatness, circularity, cylindricity, conicity, perpendicularity, parallelism, and angularity. The geometric tolerances may refer to individual surface features or related surface features. For example, the straightness, flatness, circularity, cylindricity, and conicity refer to individual surface features. The perpendicularity, parallelism, and angularity refer to related surface features.

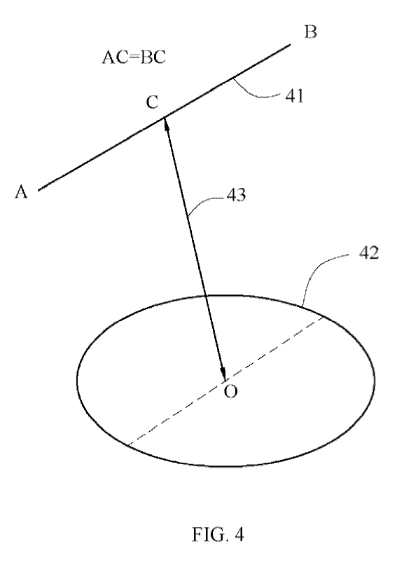

The creating module 210 is operable to create a plurality of graphical aides. Each of the graphical aides may be a picture depicting one of the defined measured characteristics. For example, a first graphical aide may be used to illustrate a center distance between two circles. A second graphical aide may be used to illustrate a maximal distance between two circles. The creating module 210 is further operable to store the graphical aides into the storage system 12. FIG. 4 illustrates one embodiment of a graphical aide depicting a line-circle distance 43 from a line 41 to a circle 42. The graphical aide shows that the line-circle distance 43 is a distance from the midpoint of the line 41 to a center of the circle 42.

The relating module 220 is operable to relate each of the defined measured characteristics to one of the graphical aides. In one embodiment, the relating module 220 may relate the defined measured characteristics to the graphical aides by applying a relational database.

The determining module 230 is operable to determine a measured characteristic to be illustrated from the defined measured characteristics. In one embodiment, the determining module 230 firstly determines one or two surface features from the measured data. The determining module 230 determines measured characteristics relevant to the one or two surface features from the defined measured characteristics. Finally, a measured characteristic to be illustrated is determined from the relevant measured characteristics. In one example, the determining module 230 determines a line and a circle from the measured data. The determining module 230 further determines relevant measured characteristics of the line and the circle including a line-circle distance, a spatial perpendicular distance, and a projection distance. The determining module 230 finally determines a line-circle distance to be illustrated.

The displaying module 240 is operable to retrieve a graphical aide related to the measured characteristic to be illustrated from the storage system 12, and display the graphical aide on the display screen 14. In one example, the displaying module 240 retrieves the graphical aide shown in FIG. 4 and displays the graphical aide on the display screen 14.

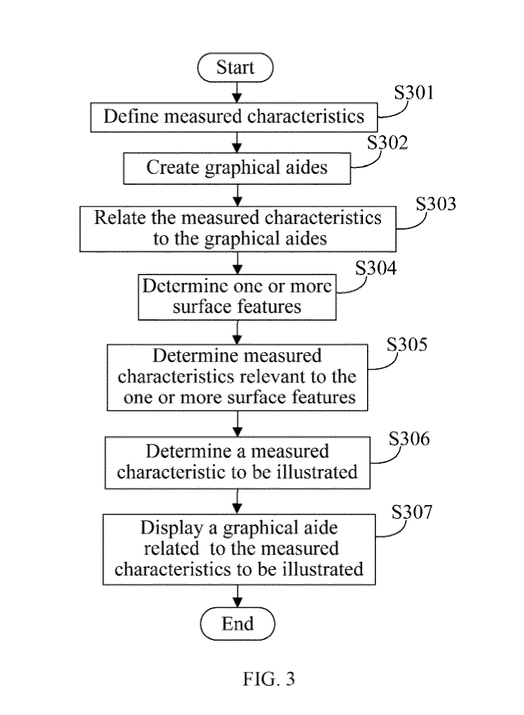

FIG. 3 is a flowchart of one embodiment of a method for dynamically displaying illustrative information of measured data. As mention above, the measured data may be obtained by the CMM 16 measuring the manufactured part 17. The measured data include a plurality of surface features. The measured characteristics define various geometric properties of the surface features, such as distance, symmetry, intersection, angle, and projection. Depending on the embodiments, additional blocks may be added, others removed, and the ordering of the blocks may be changed.

In block S301, the defining module 200 defines the measured characteristics of the measured data. In one embodiment, the defining module 200 defines various geometric tolerances, such as straightness, flatness, circularity, cylindricity, conicity, perpendicularity, parallelism, and angularity.

In block S302, the creating module 210 creates a plurality of graphical aides, and stores the graphical aides into the storage system 12. The graphical aides depict the defined measured characteristics. In one embodiment, each of the graphical aides may be an animated picture, such as an animated graphics interchange format (GIF) picture. The creating module may supplements illustrative texts to the graphical aides. In one embodiment, the creating module 210 may further creates a blank picture without any content.

In block S303, the relating module 220 relates each of the defined measured characteristics to one of the graphical aides.

In block S304, the determining module 230 determines one or more surface features from the measured data, and displays the one or more surface features on the display screen 14. In one example, the determining module 230 determines two circles from the measured data.

In block S305, the determining module 23 determines measured characteristics relevant to the one or more surface features from the defined measured characteristics, and displays the relevant measured characteristics on the display screen 14. In one embodiment, the measured characteristics are classified into various measurement types, such as a distance type, an angle type, and a direction type. The determining module 230 may determine the relevant measured characteristics according to the measurement type. In one example, the one or more surface features are two circles and the measurement type is the distance type. Accordingly, the determining module 230 determines the relevant measured characteristics that include a center distance, a projection distance, a maximal distance, and a minimal distance of the two circles.

In block S306, the determining module 230 determines a measured characteristic to be illustrated from the relevant measured characteristics. In one embodiment, if a user move a mouse pointer of the mouse 15 onto one of the relevant measured characteristics, the determining module 230 may determine the one of the relevant measured characteristics to be illustrated.

In block S307, the displaying module 240 retrieves a graphical aide related to the measured characteristic to be illustrated from the storage system 12, and displays the graphical aide on the display screen 14. In one embodiment, the displaying module 240 may display the blank picture on the display screen 14 if none of the relevant measured characteristics is determined to be illustrated.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A computing system for dynamically displaying illustrative information of measured data of a manufactured part obtained by a coordinate measuring machine, the computing system comprising:
a storage system;
at least one processor;
a display screen; and
an information displaying unit stored in the storage system and being executable by the at least one processor, the information displaying unit comprising:
a defining module operable to define a plurality of measured characteristics of the measured data;
a creating module operable to create a plurality of graphical aides and store the graphical aides into the storage system;
a relating module operable to relate each of the defined measured characteristics to one of the graphical aides;
a determining module operable to determine a measured characteristic to be illustrated from the defined measured characteristics; and
a displaying module operable to retrieve the graphical aide related to the measured characteristic to be illustrated from the storage system, and display the graphical aide on the display screen.

2. The computing system of claim 1, wherein the creating module is further operable to creating a blank picture, and the displaying module is further operable to display the blank picture upon condition that none of the defined measured characteristics is determined to be illustrated.

3. The computing system of claim 1, wherein the graphical aides are animated pictures.

4. The computing system of claim 1, wherein the creating module further supplements illustrative texts to the graphical aides.

5. The computing system of claim 4, wherein the determining module determines the measured characteristic to be illustrated according to a position of a mouse pointer of the computing system.

6. A computer-implemented method for dynamically displaying illustrative information of measured data of a manufactured part obtained by a coordinate measuring machine, the method implemented by a computerized device, and the method comprising:
defining a plurality of measured characteristics of the measured data;
creating a plurality of graphical aides and storing the graphical aides into a storage system of the computing system;
relating each of the defined measured characteristics to one of the graphical aides;
determining a measured characteristic to be illustrated from the defined measured characteristics; and
retrieving the graphical aide related to the measured characteristic to be illustrated from the storage system, and displaying the graphical aide on a display screen of the computing system.

7. The method of claim 6, further comprising:
creating a blank picture while creating the plurality of graphical aides for the defined measured characteristics; and
displaying the blank picture on the display screen upon condition that none of the defined measured characteristics is determined to be illustrated.

8. The method of claim 6, wherein the graphical aides are animated pictures.

9. The method of claim 6, wherein the graphical aides are supplemented with illustrative texts.

10. The method of claim 6, wherein the measured characteristic to be illustrated is determined according to a position of a mouse pointer of the computing system.

11. A computer-readable medium having stored thereon instructions that, when executed by a computerized device, causes the computerized device to execute a method for dynamically displaying illustrative information of measured data of a manufactured part obtained by a coordinate measuring machine, the method comprising:
defining a plurality of measured characteristics of the measured data;
creating a plurality of graphical aides and storing the graphical aides into a storage system of the computerized device;
relating each of the defined measured characteristics to one of the graphical aides;
determining a measured characteristic to be illustrated from the defined measured characteristics; and
retrieving the graphical aide related to the measured characteristic to be illustrated from a storage system of the computerized device, and displaying the graphical aide on a display screen of the computerized device.

12. The medium of claim 11, wherein the method further comprises:
creating a blank picture while creating the plurality of graphical aides for the defined measured characteristics; and
displaying the blank picture on the display screen upon condition that none of the defined measured characteristics is determined to be illustrated.

13. The medium of claim 11, wherein the graphical aides are animated pictures.

14. The medium of claim 11, wherein the graphical aides are supplemented with illustrative texts.

15. The medium of claim 14, wherein the measured characteristic to be illustrated is determined according to a position of a mouse pointer of the computing system.
